(19) United States
(12) Patent Application Publication
(10) Pub. No.: US 2008/0202846 A1
(43) Pub. Date: Aug. 28, 2008

(54) DEVICE AND METHOD FOR DAMPENING SOUND TRANSMISSION AND VIBRATION

(75) Inventor: Michael R. Gernhart, Las Vegas, NV (US)

Correspondence Address: MARGER JOHNSON & MCCOLLOM, P.C., 210 SW MORRISON STREET, SUITE 400, PORTLAND, OR, 97204, US

(73) Assignee: MTEC, LLC, Las Vegas, NV (US)

(21) Appl. No.: 12/036,656

(22) Filed: Feb. 25, 2008

Related U.S. Application Data
(60) Provisional application No. 60/891,441, filed on Feb. 23, 2007.

(51) Int. Cl. F16F 15/00

(52) U.S. Cl. 181/208

(57) ABSTRACT

A system and method is provided for dampening sound transmission and vibration for controlling noise in finished strata materials to which sound dampening channel members are attached. The system comprises a metal connector member including a base portion and at least one gripping portion joined to, and extending outwardly from, the base portion, for receiving and fixedly holding in place the metal sound dampening channel member on a structural support member. The metal sound dampening channel member being connectable to the gripping portion of the metal connector member and forming a gap therebetween without introducing energy transfer material in the gap thereby providing space for energy to dissipate throughout the gap and without creating any substantial hot spots. The metal connector member interconnected with the metal sound dampening channel member, joined to the structural support member, and attached to the finished strata material, dampening sound transmission and vibration in a frequency range up to about 6,000 Hz. in the finished strata material.

### RELATED APPLICATION

This application is a non-provisional application of provisional application Ser. No. 60/891,441 filed Feb. 23, 2007. Priority of the above-listed application is claimed. The descriptive material and drawings in the above provisional is hereby incorporated herein in their entirety by reference.

### BACKGROUND

This invention is directed to a system and method for dampening sound transmission and vibration for controlling noise, and more particularly, to dampening sound transmission and vibration for controlling noise in finished strata materials to which sound dampening channel members are attached.

Systems employing metal components for dampening sound transmission and vibration for controlling noise are known. Various materials have been used to separate these metal components to control the transfer of energy and/or heat, and in turn the ability to dampen sound transmission and vibration. For example, insulating material have been provided for this purpose. Polymeric materials has been employed to isolate two pieces of metal thereby restricting energy and/or heat transfer between the components. Fluid isolators have also been utilized for this purpose. These structures have been used in various applications including engine mounts, seismic applications, machines, pipe covers, windshield wiper motors, electric automatic garage door openers and vehicles.

In buildings metal components separated by materials as described above have been provided in elevated and sub-flooring panel systems. Impact and energy absorbing products for flat surfaces include the usage of coiled springs in conjunction with polymeric materials or metal to assist in absorbing and dissipating forces of humans and other objects coming in contact with the flat surfaces.

Sound isolators are used for noise abatement in buildings between plasterboard and block wall which are based upon three components, one of which is a center bush which is separated from a second metal component to control thermal energy transfer by materials such as natural or synthetic rubber.

### SUMMARY

A system is provided for dampening sound transmission and vibration for controlling noise in finished strata materials to which sound dampening channel members are attached. The system comprises a metal connector member including a base portion and at least one gripping portion joined to, and extending outwardly from, the base portion. The gripping portion receives and fixedly holds in place the metal sound dampening channel member on a structural support member. The sound dampening channel member typically includes a plurality of opposed outwardly extending flanges which are connected to the gripping portion of the metal connector member.

The metal sound dampening channel member is connectable to the gripping portion of the metal connector member and forms a gap therebetween. In the prior art as stated above, various materials have been used to separate metal components to control the transfer of energy and/or heat, and in turn the ability to dampen sound transmission and vibration. For example, insulating material, polymeric materials and fluid isolators has been employed to isolate two pieces of metal thereby restricting energy and/or heat transfer between the components. In the subject system, no energy transfer material is introduced in the gap. These This provides space for energy to dissipate throughout the gap and without creating any substantial hot spots. In a further embodiment, a structural member is not provided in the gap for further supporting the metal sound dampening channel member. In still a further embodiment, at least one of an electrical wire, plumbing, heating ducting, and air conditioning ducting can be located within the gap.

The metal connector member interconnected with the metal sound dampening channel member, joined to the structural support member, and attached to the finished strata material, effectively and efficiently dampens sound transmission and vibration. It reduces the number and size of direct connection points between the metal connector member and the metal sound dampening channel member which is supporting the finished strata material thereby directing the energy transmitted though the minimal number of connection points of substantially reduced size.

The system 10 is designed to progressively respond to noise pressure and or vibrations associated with noise and the control of the noise transmission from room to room within structures. The noise suppression of system 10 is measured by Sound Transmission Class (STC) and Impact Insulation Class (IIC) testing defined by ASTM standards or from outdoors indoors or from indoors outdoors such as measured by Outdoor Indoor Transmission Class (OITC) testing as defined by ASTM standards. Noise suppression can be accomplished in a frequency range in the finished strata material of up to about 6000 Hz., in a further embodiment of up to about 5,00 Hz., another embodiment of up to about 4,500 Hz., and in still a further embodiment of up to about 4,000 Hz. In another embodiment dampening can be affected at from about 4 Hz., in an additional embodiment from about 8 Hz., in a further embodiment from about 12 Hz., and in still a further embodiment from about 15 Hz.

In one embodiment the metal connector member is substantially U-shaped. In another embodiment, the gripping portion comprises a metal connector member defining at least one cut out area which receives and fixedly holds the metal sound dampening channel member.

Prior art dampening systems as described above have been used in various applications including engine mounts, seismic applications, machines, pipe covers, windshield wiper motors, electric automatic garage door openers and vehicles. In one embodiment, the structural support member is located in a building. The finished material strata in another embodiment consists essentially of ceilings and walls.

In one embodiment, the metal connector member substantially reduces the transfer of heat and/or cold through the sound dampening channel member and through the finished strata material. In another embodiment, the system further includes at least one mounting hole formed in a central portion of the metal connector member. A fastener is inserted through each mounting hole into the structural support member. This increases the ability of the finished strata material to control energy transfer by centralizing the location. It can also reduce the number of direct connection points between the metal connector member and the metal sound dampening channel member which is supporting the finished strata material thereby directing the energy transmitted though the connection points. The point connections provided by the metal connector member described herein increases a wall or ceilings ability to control energy transmission by decreasing the potential of a fastener (which supports the finished strata materials fastened to the sound dampening channel member) creating an energy short circuit into the structural member. This type of short circuit of a fastener can reduce the structural member's ability to control energy and/or noise. Creating point connections substantially increases a wall or ceilings ability to control and or reduce cracks in the membrane created by settling, or other movement of the structural member or finished strata material for the purposes of reducing the required repairs, reducing aesthetic changes and minimizing separation of the finished strata material.

A method is also provided for dampening sound transmission and vibration for controlling noise in a finished strata material. The method comprises providing the metal sound dampening channel member and the metal connector member as described above. Then, attaching the metal connector member to the structural support member. Next, the metal sound dampening channel member is connected to the gripping portion of the metal connector member and a gap is formed therebetween without introducing energy transfer material in the gap. As previously stated, this provides space for energy and/or heat to dissipate throughout the gap without creating any substantial hot spots. Finally, the finished strata material is attached to the dampening channel member for controlling noise in the sound dampening channel member, and in turn dampening sound transmission and vibration in the finished strata material.

Another method for dampening sound transmission and vibration for controlling noise in a finished strata material can also be provided. This method comprises providing the above-described metal sound dampening channel member and metal connector member, and connecting the metal sound dampening channel member to the gripping portion of the metal connector member and forming a gap therebetween. Then, the interconnected metal connector member and metal sound dampening channel member are attached to the structural support member. Finally, the finished strata material is attached to the dampening channel member for controlling noise in the sound dampening channel member, and in turn dampening sound transmission and vibration in the finished strata material.

The system can also comprise an intermediate connection device connected between the metal connector device and the structural support member. The foregoing can be assembled in such a way as to detach and decouple the system from the structural support member thereby terminating the transfer of energy and vibration from the structural support members to the finish strata materials. In one embodiment the system is supported by the intermediate connection device in a perpendicular plane to the structural member's vertical plane. In one embodiment the system can be attached to a bracket and in another embodiment to a rod member supported by a bracket. In a further embodiment the rod is supported by a spring mounted bracket.

### DRAWINGS

FIG. 1 is a perspective view of system 10 for dampening sound transmission and vibration attached to a structural support member 30.

FIG. 2 is perspective view of system 10 and structural support member 30 as in FIG. 1 and having a sound dampening channel 20 connected to system 10.

FIG. 3 is a perspective view of system 10 attached to structural support member 30 and connected to sound dampening channel 20, and having finished strata material 40 attached to channel 20.

FIG. 4 is a perspective view of system 10.

FIG. 5A is a side view of system 10 attached to structural support member 30, via L-shaped bracket 60, and connected to sound dampening channel 20, and having finished strata material 40 attached to channel 20.

FIG. 5B is a sectional view of the view depicted in FIG. 5A.

FIG. 6A is a side view of system 10 attached to structural support member 30, via L-shaped bracket 60 and interconnecting fastener 51, and connected to sound dampening channel 20, and having finished strata material 40 attached to channel 20.

FIG. 6B is a sectional view of the view depicted in FIG. 6A.

FIG. 7A is a side view of system 10 attached to structural support member 30, via F-shaped bracket 60, and connected to sound dampening channel 20, and having finished strata material 40 attached to channel 20.

FIG. 7B is a sectional view of the view depicted in FIG. 7A.

FIG. 8 is perspective view of system 10 and structural support member 30 as in FIG. 1 and further including a resilient isolator pad 90 therebetween.

### DETAILED DESCRIPTION

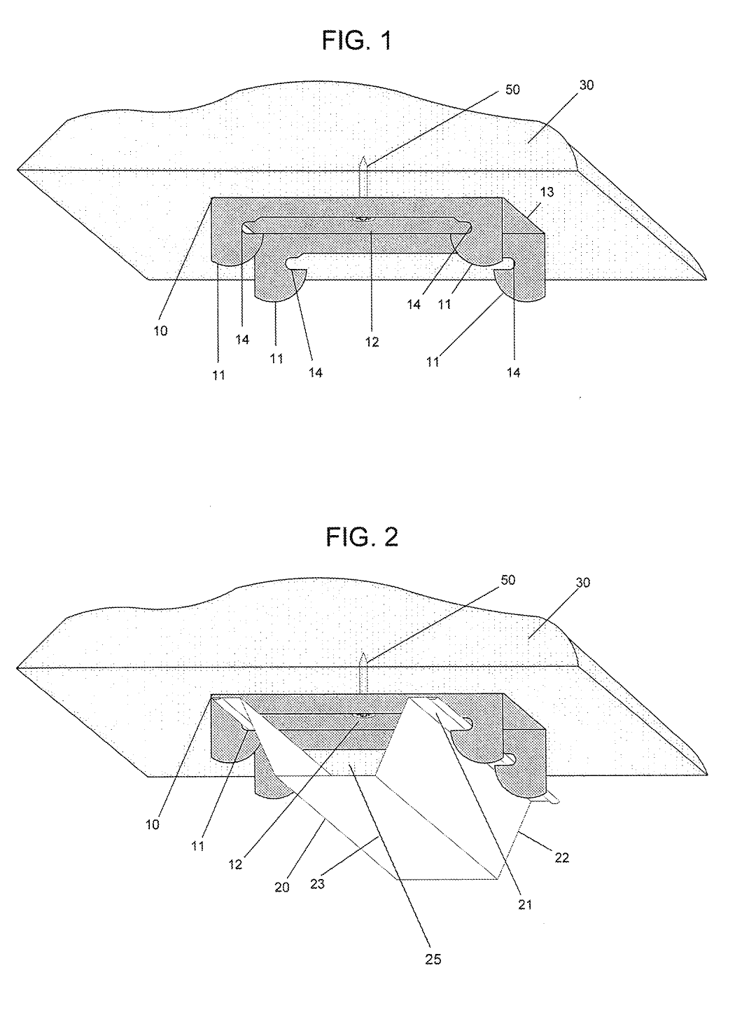

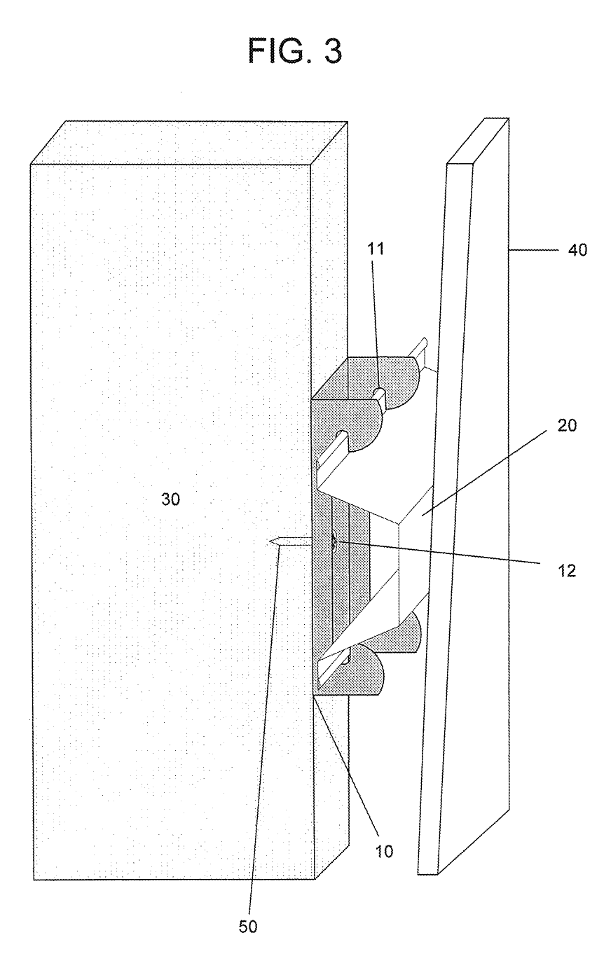

Referring now to FIGS. 1 and 2, a system 10 is depicted attached to structural support member 30 for dampening sound transmission and vibration for controlling noise in a finished strata material 40 (see FIG. 3).

The system 10 is designed to control noise (sound) transmission in the structure born path and control structure born and vibration associated with such as noise. The system through the utilization and unique implementation of dampening, control the vibration (noise) in the substrate and in the finished strata materials attached to the sound dampening channel members. The systems dampening effect provides improved Noise Reduction Class (NRC) acoustical performance of finished surfaces (strata) within rooms.

System 10 is a metal connector member including a base portion 13 and a plurality of gripping portions 11. The metal connector member 10 is substantially U-shaped. The gripping portions 11 are joined to, and extend outwardly from, the base portion 13, for receiving and fixedly holding in place metal sound dampening channel member 20 on structural support member 30. Each gripping portion 11 defines a cut out area or slot 14 which receives and fixedly holds the metal sound dampening channel member 20. The gripping portions 11 can comprise a flange member having a slot 14 located therein for performing the gripping function described above.

System 10 is fabricated from a metal, and forms a metal to metal connection with metal sound dampening channel member 20. The metal employed for use as system 10 is typically steel, although other metals and metal alloy may be employed herein. In high temperature applications, metals such as coil steel can be used.

A hole 12 is formed in center of the base 13. A fastener 50 is inserted through hole 12 into the structural support member 30. For example, fastener 50 can be an anchor, pin, screw or nail. As previously stated, the ability of the finished strata material to control energy transfer is controlled by centralizing the location of attachment of the system 10 to the support structure 30 and providing a point connection(s) in the central area of base 13. This reduction in the number of direct connection points between the metal connector member 10 and the structural support member 30, and in turn with respect to the metal sound dampening channel member 20, is for purposes of directing the energy transmitted thought these connection points (see FIG. 3).

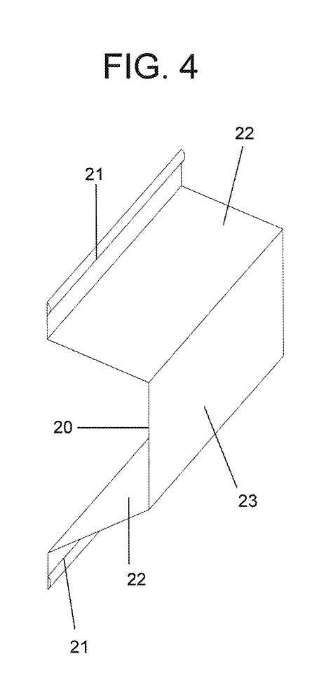

Referring to FIG. 2 and FIG. 4, metal sound dampening channel member 20 comprises a base section 23 which attaches to a finished strata material 40. A pair of angularly extending sidewall section 22 are joined to the respective ends of the base section 23.

A gap 25 is defined within the area formed by the base section 23 and the side wall sections 22, respectively. A further structural member of any type is not required to be introduced into the gap 25 for supporting the metal sound dampening channel member 20. Structural support member 30 is typically located in a building. Building utilities such as electrical wire, plumbing, heating ducting, air conditioning ducting, etc., can be located within the gap 25.

A pair of outwardly extending end sections 21 are joined to the respective ends of the side wall sections 22. The end wall sections 22 are received within the cut out area or slot 14 for fixedly holding in place metal sound dampening channel member 20 on structural support member 30. The channel member 20 can be in the form of a conventional drywall furring channel or a resilient channel (such as the R2 resilient channel manufactured by Dietrich Metal Framing).

Regarding FIG. 3, the arrangement of system 10 attached to structural support member 30 and connected to metal sound dampening channel member 20 of FIG. 2 is depicted. This assembly of FIG. 2 for dampening sound transmission and vibration for controlling noise is shown in combination with finished strata material 40. Material 40 can be either a ceiling or a wall. Material 40 is typically a sheet good material, for example, a wallboard panel such as gypsum wallboard or plywood.

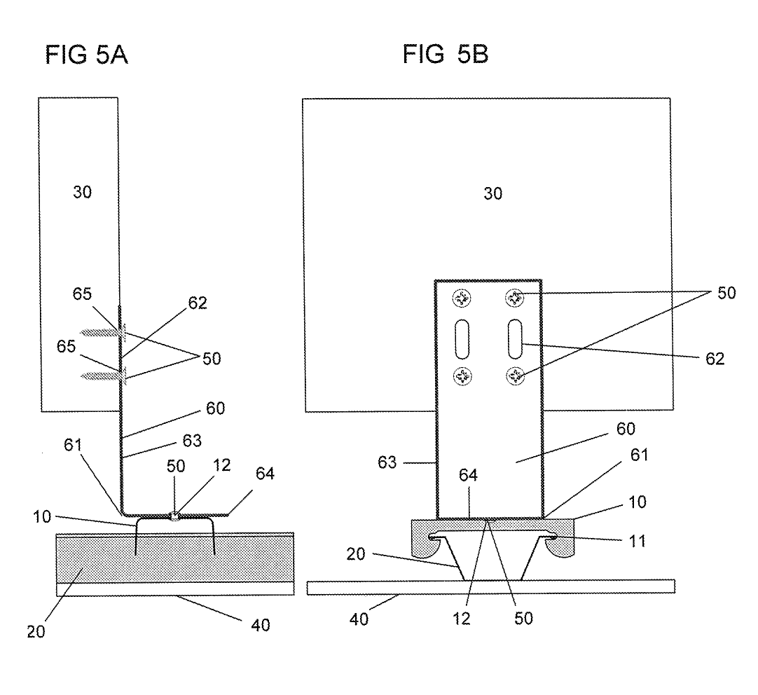

FIG. 5A is a side view of system 10 attached to structural support member 30, via an intermediate connection device which can be L-shaped bracket 60, and connected to sound dampening channel 20, and having finished strata material 40 attached to channel 20. FIG. 5B is a sectional view of the view depicted in FIG. 5A. System 10, member 30, channel 20, and strata material 40 have been described above. System 10, channel 20, and strata material 40 are interconnected one to the other as described above with respect to FIG. 3. Referring to FIG. 5A and 5B, system 10 is attached to strata material 40 via L-shaped bracket 60 which is turn connected to member 30.

The bracket 60 comprises a first elongate rectangular bracket portion 63 joined at substantially right angle to a second rectangular bracket portion 64 to form a rectangular bend 61. The first elongate rectangular bracket portion 63 includes four holes 65 through which fasteners 50 are inserted into the structural support member 30 to attach the bracket 50 to member 30 to detach and decouple the system 10 from the structural member 30 thereby substantially reducing the transfer of energy and vibration from the structural member to the finish material 40 supported in a perpendicular plane to the structural member's vertical plane. Bracket member 60 also includes connecting slits 62 for providing temporary vertical adjustment when positioning bracket member 60 with respect to member 30. Bracket member 60 can be slid up and down along a fastener 50 located within slits 62 until bracket member 60 is in the proper vertically aligned position. Then, fasteners 50 can be introduced through holes 12 in bracket 60 and permanently fixed into structural member 30. Second rectangular bracket portion 64 includes a mounting hole 12 through which fastener 50 is inserted to attach the bracket 60 to system 10.

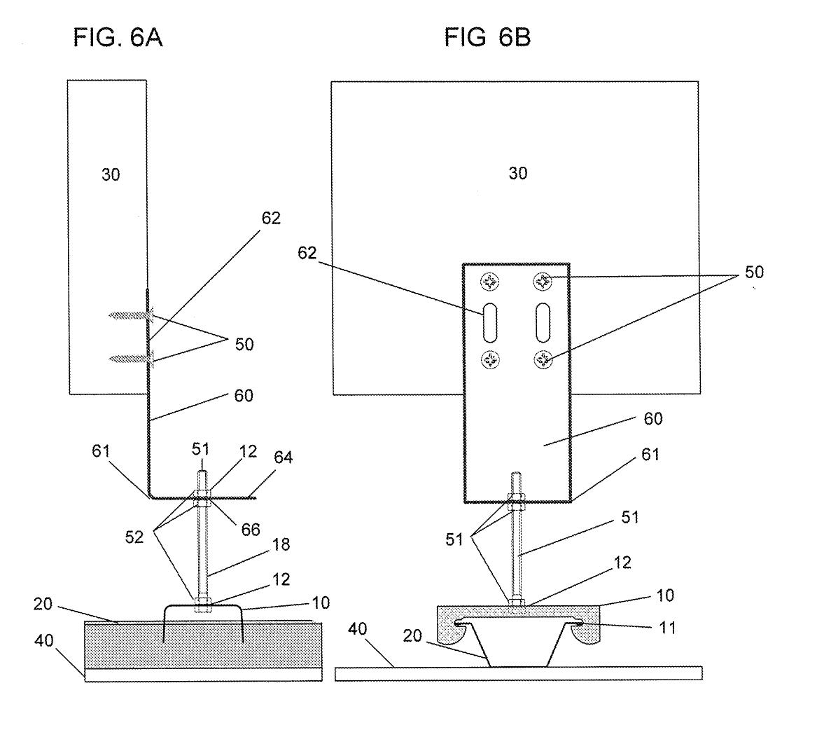

FIG. 6A is a side view of system 10 attached to structural support member 30, via an intermediate connection device 100 which can be L-shaped bracket 60 and interconnecting fastener 51, and to sound dampening channel 20, respectively. Finished strata material 40 is attached to channel 20 as described above. FIG. 6B is a sectional view of the view depicted in FIG. 6A. System 10, member 30, channel 20, bracket member 60 and strata material 40 have been described above. System 10, channel 20, bracket 60 and strata material 40 are interconnected one to the other as described above with respect to FIGS. 3, 5A and 5B. System 10 is connected to strata material 40 as described above. Second rectangular bracket portion 64 includes a mounting hole 66 through which fastener 51 is inserted to interconnectingly attach the bracket 60 to system 10 through mounting opening 12. Fastener 51 can be a rod or bolt, typically a threaded rod or bolt lockingly held in place within mounting hole 66 and mounting opening 12 by nuts 52.

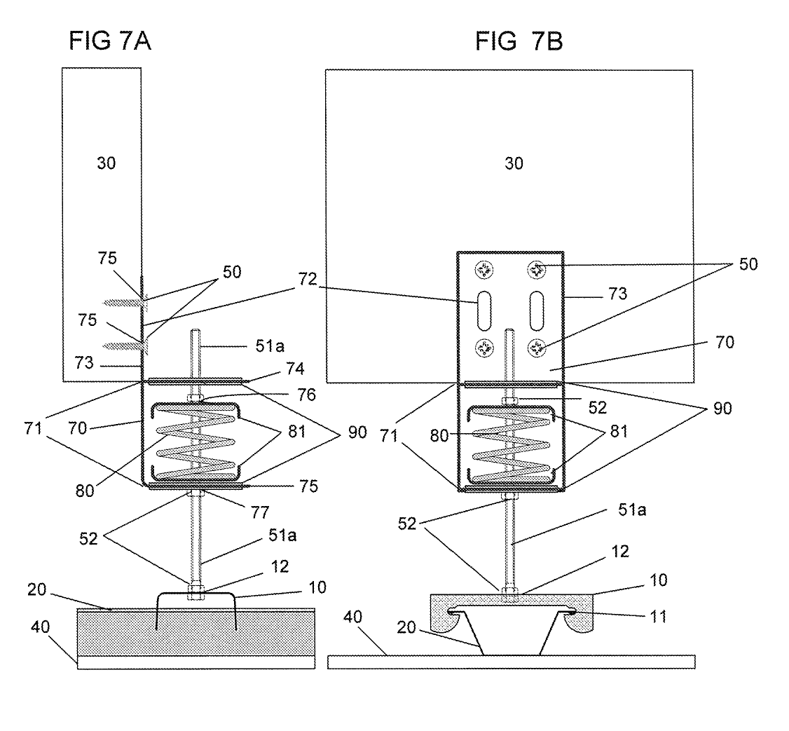

FIG. 7A is a side view of system 10 attached to structural support member 30, via F-shaped bracket 60, and connected to sound dampening channel 20, and having finished strata material 40 attached to channel 20, respectively. FIG. 7B is a sectional view of the view depicted in FIG. 7A. System 10, member 30, channel 20, and strata material 40 have been described above. System 10, channel 20, and strata material 40 are interconnected one to the other as described above with respect to FIG. 3. System 10 is connected to strata material 40 via F-shaped bracket 70 and interconnecting fastener 51.

The bracket 70 comprises a first elongate rectangular bracket portion 73 joined at substantially right angles to a second rectangular bracket portion 74 and a third rectangular bracket portion 75, respectively, both of which form rectangular bends. The first elongate rectangular bracket portion 73 includes four holes 75 through which fasteners 50 are inserted into the structural support member 30 to attach the bracket 50 to member 30. Bracket member 70 also includes connecting slits 72. Second and third rectangular bracket portion 74 and 75 include mounting holes 76 and 77 through which interconnecting fastener 51a is inserted to attach the bracket 70 to system 10. Fastener 51a is held in place by nuts 52. Second and third rectangular bracket portion 74 and 75 also each engage and support resilient isolator pads 90. Resilient isolator pads 90 are provided for purposes of which increase the energy blocking capacity of the system 10. Pads 90 can function as isolation members which inhibit energy transmission to member 30. In one embodiment pads 90 can be fabricated from a natural or synthetic polymer. Located between second and third rectangular bracket portion 74 and 75 is a spring member 80 which is held in place by mounting connectors 81 which in turn are attached to fastener 51a. Spring members 80 are provided for substantially reducing the transfer of all energy (heat, vibration, sound) from the support structure to the metal sound dampening channel. Spring member 80 in one embodiment can comprise a straight, helical or conical shaped spring. Mounting connectors 81 in another embodiment can comprise a cup shaped metal washer. In a further embodiment the mounting connector 81 is a metal member lined with a polymeric material.

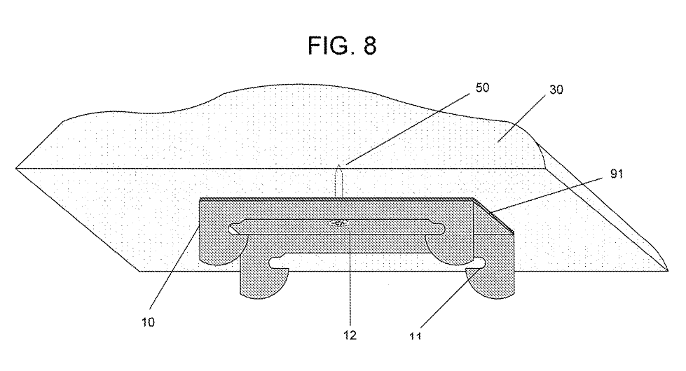

FIG. 8 is perspective view of system 10 and structural support member 30 as in FIG. 1 and further including a grommet 91 therebetween. System 10, grommet 90 and member 30 have been described above. Grommet 91 is similar in function to grommet 90 but is rectangular in shape having substantially the same perimeter configuration as member 30. As described above, a fastener 50 is inserted through hole 12 in member 10 into the structural support member 30 to attach member 10 to member 30.

I claim:

1. A system for dampening sound transmission and vibration for controlling noise in finished strata materials to which sound dampening channel members are attached, which comprises:
a metal connector member including a base portion and at least one gripping portion joined to, and extending outwardly from, said base portion, for receiving and fixedly holding in place said metal sound dampening channel member on a structural support member,
said metal sound dampening channel member being connectable to said gripping portion of said metal connector member and forming a gap therebetween without introducing energy transfer material in the gap thereby providing space for energy to dissipate throughout the gap and without creating any substantial hot spots,
said metal connector member interconnected with said metal sound dampening channel member, joined to said structural support member, and attached to said finished strata material, dampening sound transmission and vibration in a frequency range up to about 6,000 Hz. in said finished strata material.

2. The system of claim 1, wherein said metal connector member is substantially U-shaped.

3. The system of claim 1, wherein said gripping portion comprises a metal connector member defining at least one cut out area which receives and fixedly holds the metal sound dampening channel member.

4. The system of claim 1, wherein said sound dampening channel member includes a plurality of opposed outwardly extending flanges which are connected to said gripping portion of said metal connector member.

5. The system of claim 1, wherein said finished material strata consists essentially of ceilings and walls.

6. The system of claim 1, wherein said metal connector member substantially reduces the transfer of heat and/or cold through said sound dampening channel member and through said finished strata material.

7. The system of claim 1, which further includes at least one mounting hole formed in a central portion of the metal connector member and a fastener which is inserted through each said mounting hole into said structural support member thereby increasing the ability of the finished strata material to control energy transfer by centralizing the location, and reducing the number, of direct connection points between the metal connector member and the metal sound dampening channel member which is supporting the finished strata material for purposes of reducing the energy transmitted thought the connection points.

8. The system of claim 1, wherein at least one of an electrical wire, plumbing, heating ducting, and air conditioning ducting can be located within the gap.

9. The system of claim 1, wherein the structural support member is located in a building.

10. The system of claim 1, wherein said metal sound dampening channel member is connected to said gripping portion of said metal connector member without providing a structural member in the gap for further supporting the metal sound dampening channel member.

11. A method for dampening sound transmission and vibration for controlling noise in a finished strata material, which comprises:
providing a metal sound dampening channel member for dampening sound transmission and vibration for controlling noise in said finished strata material;
providing a metal connector member including a base portion and at least one gripping portion joined to, and extending outwardly from, said base portion, for receiving and fixedly holding in place said metal sound dampening channel member on said structural support member;
connecting said metal sound dampening channel member to said gripping portion of said metal connector member and forming a gap therebetween without introducing energy transfer material in the gap thereby providing space for energy to dissipate throughout the gap and without creating any substantial hot spots;
attaching said interconnected metal connector member and metal sound dampening channel member to said structural support member; and
attaching said finished strata material to said dampening channel member for controlling noise in said sound dampening channel member, and in turn dampening sound transmission and vibration in a frequency range up to about 6,000 Hz. in said finished strata material.

12. The method of claim 11, wherein said metal connector member is substantially U-shaped.

13. The method of claim 11, wherein said gripping portion comprises a metal connector member defining cut out areas which receive and fixedly hold the metal sound dampening channel member.

14. The method of claim 11, wherein said sound dampening channel member includes a plurality of opposed outwardly extending flanges which are connected to said gripping portion of said metal connector member.

15. The method of claim 11, wherein said finished material strata consists essentially of ceilings and walls.

16. The method of claim 11, wherein said system for dampening sound transmission and vibration substantially reduces the transfer of heat and/or cold through said sound dampening channel member, and through said finished strata materials.

17. The method of claim 11, wherein attaching said interconnected metal connector member and metal sound dampening channel member said finished strata material to said structural support member comprises forming at least one mounting hole in a central portion of the metal connector member and inserting a fastener through each said mounting hole into said structural support member thereby increasing the ability of the finished strata material to control energy transfer by centralizing the location, and reducing the number, of direct connection points between the metal connector member and the metal sound dampening channel member which is supporting the finished strata material for purposes of reducing the energy transmitted thought the connection points.

18. The method of claim 11, wherein at least one of an electrical wire, plumbing, heating ducting, and air conditioning ducting can be located within the gap.

19. The method of claim 11, wherein the structural support member is located in a building.

20. The method of claim 11, wherein said metal sound dampening channel member is connected to said gripping portion of said metal connector member without providing a structural member in the gap for further supporting the metal sound dampening channel member.

21. A method for dampening sound transmission and vibration for controlling noise in a finished strata material, which comprises:
providing a metal sound dampening channel member for dampening sound transmission and vibration for controlling noise in said finished strata material;
providing a metal connector member including a base portion and at least one gripping portion joined to, and extending outwardly from, said base portion, for receiving and fixedly holding in place said metal sound dampening channel member on said structural support member;
attaching said metal connector member to said structural support member;
connecting said metal sound dampening channel member to said gripping portion of said metal connector member and forming a gap therebetween without introducing energy transfer material in the gap thereby providing space for energy and/or heat to dissipate throughout the gap without creating any substantial hot spots; and
attaching said finished strata material to said dampening channel member for controlling noise in said sound dampening channel member, and in turn dampening sound transmission and vibration in a frequency range up to about 6,000 Hz. in said finished strata material.
